(19) United States
(12) Patent Application Publication
(10) Pub. No.: US 2021/0197309 A1
(43) Pub. Date: Jul. 1, 2021

(54) METHOD AND DEVICE FOR DETECTING AN IMPENDING INCOMPLETE CUT OR AN INCOMPLETE CUT WHICH HAS ALREADY OCCURRED WHEN THERMALLY SEPARATING A WORKPIECE

(71) Applicant: MESSER CUTTING SYSTEMS GMBH, Gross-Umstadt (DE)

(72) Inventors: Murat Cetin BAYRAM, Michelstadt (DE); Thomas MÜLLER, Gross-Umstadt (DE)

(73) Assignee: Messer Cutting Systems GmbH, Gross-Umstadt (DE)

(21) Appl. No.: 15/777,359

(22) PCT Filed: Nov. 14, 2016
(86) PCT No.: PCT/EP2016/077542

§ 371 Date: May 18, 2018

(30) Foreign Application Priority Data
Nov. 18, 2015 (DE) 10 2015 119 938.6

(51) Int. Cl. B23K 26/03; B23K 26/38; B23K 31/10; B23K 26/08; B23K 26/06

(52) U.S. Cl. CPC B23K 26/03; B23K 26/38; B23K 26/0626; B23K 26/08; B23K 31/10

(57) ABSTRACT

In order to be able to detect a possible loss of cut during the thermal separation of a workpiece as early as during the separation, the invention proposes a method for detecting an impending loss of cut or a loss of cut that has already occurred, in which energy is input into a cutting region and which comprises the following method steps:
a) applying a first alternating signal to the workpiece,
b) identifying a second alternating signal caused by the first alternating signal in a measurement electrode spaced apart from the workpiece,
c) ascertaining the phase shift between the first and second alternating signal by outputting a phase shift signal,
d) comparing the phase shift signal with a prescribed upper limit value and a prescribed lower limit value for the phase shift signal,
   wherein, when the phase shift signal exceeds the upper limit value or undershoots the lower limit value, the energy input is changed, for example, by stopping the thermal separation of the workpiece.

The present invention relates to a method for detecting a loss of cut during the thermal separation of a workpiece, in which energy is input into a cutting region.

The present invention furthermore relates to an apparatus for detecting a loss of cut during the thermal separation of a workpiece.

The method and apparatus within the context of the invention are used during the thermal separation of workpieces, for example during cutting of sheet metal using a cutting torch, laser or plasma cutter. The method and the apparatus make it possible to detect a loss of cut in an automated manner; said method and apparatus can therefore be used, in particular, in oxyacetylene cutting, plasma cutting or laser cutting machines.

### PRIOR ART

During the cutting of metal workpieces, cutting errors can occur. A common cutting error is the loss of cut, which is characterized by an incompletely formed cutting gap.

In the case of a loss of cut, the workpiece to be separated is often not fully melted in a region of the cutting gap facing away from the processing head or the actually cut workpiece parts are connected to one another again by resolidifying slag.

If a loss of cut is not noticed or is noticed too late, this can lead to excessively severe wear of the cutting machine, in particular of the cutting nozzle; in the case of laser cutting machines, it can even lead to lenses breaking. An undetected loss of cut therefore often causes significant standstill periods of the machine. It is therefore desirable, in principle, to monitor the cutting process for erroneous cuts continuously, such that damage to the cutting machine is prevented as far as possible.

Known methods used to detect a loss of cut mostly utilize optical sensor systems. These sensors are often arranged in such a way that they can sense a passage of radiation through the workpiece in the region of the cutting gap or they are designed to sense the light emission of the plasma produced during the processing of the workpiece or the stray radiation that can be produced in the case of a loss of cut by reflection on the incompletely cut workpiece.

A requirement for these methods is the use of optical sensors, which can detect the presence of specific radiation components and the intensity thereof. However, the use of optical sensors demands a certain installation space. Moreover, the sensors are arranged either in the vicinity of the workpiece, such that they are subjected to high thermal loads under separation conditions, or they are arranged at a distance from the separation process, such that the signal of the sensor generally has to be ampli-fled. Furthermore, optical sensors have the disadvantage that there are influencing factors in the beam path that change the sensor signal, for example the nozzle di-ameter.

There is therefore the basic demand for a simple method for detecting a loss of cut that dispenses with optical sensors.

Such a method is known from DE 198 47 365 C2. Instead of an optical detection system, an LC resonant circuit is provided, the capacitance of which is determined by the capacitance present between the processing head and the workpiece. If a loss of cut occurs, a portion of the plasma produced during the thermal processing remains in the intermediate space between the processing head and the workpiece. As a result thereof, the capacitance in the LC resonant circuit changes. The plasma in the intermediate space produces a sudden increase in amplitude in the LC generator output signal that serves as an indicator for a loss of cut.

In this method, the detection of a loss of cut essentially depends on the identification of the increase in amplitude in the LC generator output signal. However, the amplitude level is influenced by a multiplicity of factors, for example by the resistances present in the resonant circuit and the size of the intermediate space, but, in particular, by the distance between the processing head and the workpiece. Even small changes in distance between the workpiece and the processing head are often associated with a change in the amplitude level. Moreover, the LC generator output signal often has background noise, which makes it difficult to identify a loss of cut precisely, in particular to identify a loss of cut at an early stage.

This holds true, in particular, in smaller workpieces, since the shape thereof can influ-ence the capacitance of the resonant circuit and can contribute to a noise signal being superposed on the LC generator output signal. In particular, a low amplitude level and a poor signal-to-noise ratio make it difficult to detect a potential loss of cut at as early a stage as possible.

### Technical Object

The invention is therefore based on the object of specifying a method for detecting an impending loss of cut or a loss of cut that has already occurred that makes it possible to detect an impending loss of cut at an early stage.

The invention is furthermore based on the object of specifying an apparatus for detecting an impending loss of cut or a loss of cut that has already occurred that makes it possible to detect an impending loss of cut at an early stage.

### General Description of the Invention

With respect to the method, the object mentioned above is achieved according to the invention by virtue of the method comprising the following method steps:
a) applying a first alternating signal to the workpiece,
b) identifying a second alternating signal caused by the first alternating signal in a measurement electrode spaced apart from the workpiece,
c) ascertaining the phase shift between the first and second alternating signal by outputting a phase shift signal,
d) comparing the phase shift signal with a prescribed upper limit value and a prescribed lower limit value for the phase shift signal,
   wherein, when the phase shift signal exceeds the upper limit value or undershoots the lower limit value, the energy input is changed.

The invention is based on the idea of detecting the occurrence of a loss of cut at as early a stage as possible with the aim of taking suitable measures to counteract the complete formation of the loss of cut.

According to the invention, two modifications are therefore proposed, one of which relates to an improved method for detecting a loss of cut and the other relates to suitable measures for preventing a loss of cut.

In contrast to known methods using an LC resonant circuit, an evaluation of the amplitude signal is omitted. Instead, according to the invention, a differential measurement method is applied for detecting a loss of cut, in which two signals are used and the phase shift thereof with respect to one another is determined, namely a measurement signal, which is output by a measurement electrode, and a reference signal, with which the measurement signal of the measurement electrode is correlated. The phase shift signal is generated by comparing the phase of the measurement signal and the reference signal. Said phase shift signal is a corrected evaluation signal, in which measurement errors are eliminated and which has a particularly good signal-to-noise ratio.

A temporally changing signal (first alternating signal) is first applied to the workpiece for this purpose. The first alternating signal is preferably an alternating voltage signal U₁ (t). The first alternating signal generates, in an electrode arranged at a distance from the workpiece, a second alternating signal, for example an alternating current signal I_{t,φ}(t), which is used as the measurement signal and which has a phase shift with respect to the first alternating signal (reference signal). It has been shown that the phase shift signal depends on the measurement electrode and the workpiece formed capacitance. As the distance of the measurement electrode from the workpiece increases, the magnitude of the phase shift signal increases. Given a constant distance between the measurement electrode and the workpiece, the capacitance is primarily determined by the dielectric constant of the dielectric. In the case of a loss of cut, since plasma forms increasingly in the intermediate space between the measurement electrode and the workpiece, the composition of the dielectric and hence the capacitance formed by the measurement electrode and the workpiece changes. At the same time, a change in the phase shift signal is observed by the changed capacitance.

To be able to detect the phase shift as precisely as possible, the first alternating signal is used as the reference signal. The phase shift is ascertained by a comparison of the first alternating signal with the second alternating signal. In this case, it has proven expedient when the first alternating signal serving as the reference signal for ascertaining the phase shift is first inverted, the amplitude of the first and second alternating signal are coordinated and matched with one another and the first and the second alternating signal are then added. In this case, provided there is no phase shift, the first and second alternating signal cancel each other out. However, if there is a phase shift, a phase shift signal is obtained, the level and direction of which depends on the phase shift. The phase shift signal changes when the distance between the measurement electrode and the workpiece changes and when the dielectric changes due to plasma formation in the intermediate space.

Moreover, according to the invention, measures that can be used to react to a detected impending loss of cut are specified. A common cause for a loss of cut is that the amount of energy input into the cutting region is too low. The cutting region is under-stood here to be the part of the cutting kerf into which energy is input for the purpose of melting same. Reasons for too low an amount of energy can be, for example, an incorrect position of the cutting device, an incorrect focal position of the laser, too high a workpiece material strength, too short a residence time over the later cutting gap or too high a cutting rate.

A loss of cut can in most cases be counteracted independently of the cause when the energy input is increased, that is to say more energy is provided per unit area of the cutting region. This can be achieved, for example, by virtue of increasing the cutting power of the processing tool, varying the focal position of a laser or reducing the separation rate.

The aforementioned measure contributes to being able to counteract an impending loss of cut when it is detected, such that a loss of cut, damage to the workpiece and an interruption of the method are prevented. As a result thereof, a particularly efficient and cost-effective method is obtained.

It has proven expedient when the thermal separation is effected at a separation rate and when the energy input is changed by reducing the separation rate.

The separation rate is the rate at which the workpiece is separated as seen in the cutting direction, that is to say the rate at which the cut is extended. Said rate is given in millimeters per minute (mm/min). The separation rate is a parameter that can be adjusted quickly and easily. The adjustment of said separation rate therefore makes it possible to react quickly to the detection of a loss of cut. Moreover, said separation rate can be set easily, since known cutting machines regularly have a movement unit for the cutting unit or the workpiece that can be used to move the cutting unit, for example a laser cutting, oxyacetylene cutting or plasma cutting head, and the workpiece surface relative to one another.

In this connection, it has proven to be advantageous when the separation rate is reduced in steps.

In order to be able to counteract an impending loss of cut efficiently, it is often necessary to adjust the separation rate quickly. In particular, stepped reduction of the separation rate is associated with a rapid increase in the energy input. At the same time, the evaluation of the changes in the phase shift signal can be monitored and can be used as the basis for a further stepped change in the separation rate. It has proven to be advantageous when the separation rate is first reduced by a percentage in a range of 15% to 40%, preferably by 20%, compared to the original separation rate and then adjusted in steps depending on the phase shift signal, preferably at a step width in the range of 2% to 10%, particularly preferably in steps of ±5% based on the original separation rate.

In one preferred configuration of the method, there is provision, after the reduction of the separation rate, for the separation rate to be increased again when the phase shift signal is back in the range between the lower and upper limit value.

After the reduction of the energy input into the cutting region, the phase shift signal regularly returns back to a value range that is within the range between the upper and lower limit value and that corresponds approximately to the value range before the impending loss of cut. In this case, it has proven expedient to lift the separation rate in steps again. As a result thereof, it is possible to return back to the original separation rate, such that an optimized, efficient separation method is guaranteed.

In a likewise preferred configuration of the method, the energy input is changed by stopping the thermal separation of the workpiece.

An interruption of the thermal separation of the workpiece is likewise suitable for reducing damage to machine components of the cutting machine; said interruption con-stitutes a measure that is particularly simple to carry out.

In one suitable modification of this procedure, there is also provision, after the stopping of the thermal separation of the workpiece, for a separation process to be started again from a loss of cut point.

The loss of cut point is the point at which the loss of cut arises. It may be necessary, where appropriate, to move the cutting beam back to the loss of cut point.

In a further preferred modification of the method, there is provision, during thermal separation, for the measurement electrode distance from the workpiece to be kept at a prescribed distance setpoint value using distance regulation and, when the phase shift signal exceeds the upper limit value or undershoots the lower limit value, for the measurement electrode to be set to a prescribed fixed position.

Planar workpiece surfaces often have uneven portions, which can adversely affect the accuracy of the loss of cut method. However, even in the case of workpieces with different workpiece heights, it is desirable to retain the most uniform distance possible from the workpiece for the purpose of achieving a good signal-to-noise ratio in the phase shift signal. Distance regulation that is used to regulate the measurement electrode distance to a prescribed setpoint value contributes to an improved signal-to-noise ratio. In the case of an impending loss of cut, simultaneous distance regulation of the measurement electrode distance can, however, contribute to an increase in the measurement accuracy, since the accuracy of distance regulation is also regularly adversely affected by the plasma produced in the loss of cut. In the case of an impending loss of cut, in order to optimize the signal-to-noise ratio during the loss of cut measurement, the measurement electrode is preferably set to a prescribed, fixed height position, preferably to the distance set before the loss of cut, when the upper limit value is exceeded or the lower limit value is undershot. As a result thereof, distance-dependent error signals are reduced.

In this connection, it has proven expedient when the prescribed fixed height position is ascertained from height values or distance values of the measurement electrode with respect to the workpiece surface in a time interval before the upper limit value is exceeded or the lower limit value is undershot.

An optimized height position of the measurement electrode or an optimized distance can be ascertained in good approximation from the height values or the distance values of the measurement electrode immediately before one of the limit values is exceeded.

When the phase shift signal exceeds the upper limit value or undershoots the lower limit value, a warning signal is preferably output.

The output of a warning signal indicates a potential or actual loss of cut to the operating personnel. This contributes to the operating personnel being able to manually in-tervene in the automated cutting method where necessary—for example in the case of unsuccessful prevention of a loss of cut.

With respect to the apparatus, the aforementioned object is achieved by an apparatus for detecting a loss of cut during the thermal separation of a workpiece, which has: an alternating signal generator for generating a first alternating signal, a measurement electrode, which is spaced apart from the workpiece, for identifying a second alternating signal caused by the alternating signal in the measurement electrode, a phase discriminator for ascertaining a phase shift between the first and the second alternating signal, wherein the phase discriminator outputs a phase shift signal, and an electronic circuit for comparing the phase shift signal with a prescribed upper limit value and a prescribed lower limit value for the phase shift signal, wherein the electronic circuit is designed in such a way that it changes the energy input when the upper limit value is exceeded or the lower limit value is undershot.

The apparatus makes it possible to detect a potential loss of cut at as early a stage as possible and to take suitable measures to counteract the complete formation of the loss of cut.

To this end, an alternating signal generator suitable for generating a first alternating signal that can be applied to the workpiece is provided. The first alternating signal is preferably an alternating voltage signal U₁ (t). The first alternating signal causes, in an electrode arranged at a distance from the workpiece, a second alternating signal, which is detected using a measurement electrode, which is at a distance from the workpiece. The second alternating signal, for example an alternating current signal I_{1, φ} (t), and the first alternating signal are applied as measurement signal to a phase discriminator, which outputs a phase shift signal from which the phase shift of both signals can be derived. It has been shown that the phase shift depends on the capacitance formed by the measurement electrode and the workpiece, said capacitance being determined primarily by the dielectric constant of the dielectric given a constant distance between the measurement electrode and the workpiece. In the case of a loss of cut, since plasma forms increasingly in the intermediate space between the measurement electrode and the workpiece, the composition of the dielectric and hence the capacitance formed by the measurement electrode and the workpiece changes. The phase shift signal is changed as a result of the changed capacitance.

An electronic circuit, which is designed to monitor the phase shift signal for the exceeding or undershooting of prescribed limit values, is furthermore provided. The electronic circuit is designed in this case in such a way that it changes the energy input into the cutting region of the workpiece when the upper limit value is exceeded or the lower limit value is undershot.

Since a common cause for a loss of cut is that the amount of energy input into the cutting region is too low, changing the energy input can in most cases counteract a loss of cut when the energy input is increased, that is to say more energy is provided per unit area of the cutting region.

### EXEMPLARY EMBODIMENT

The invention is described in more detail below with reference to exemplary embodi-ments and two drawings. In detail and illustrated schematically:

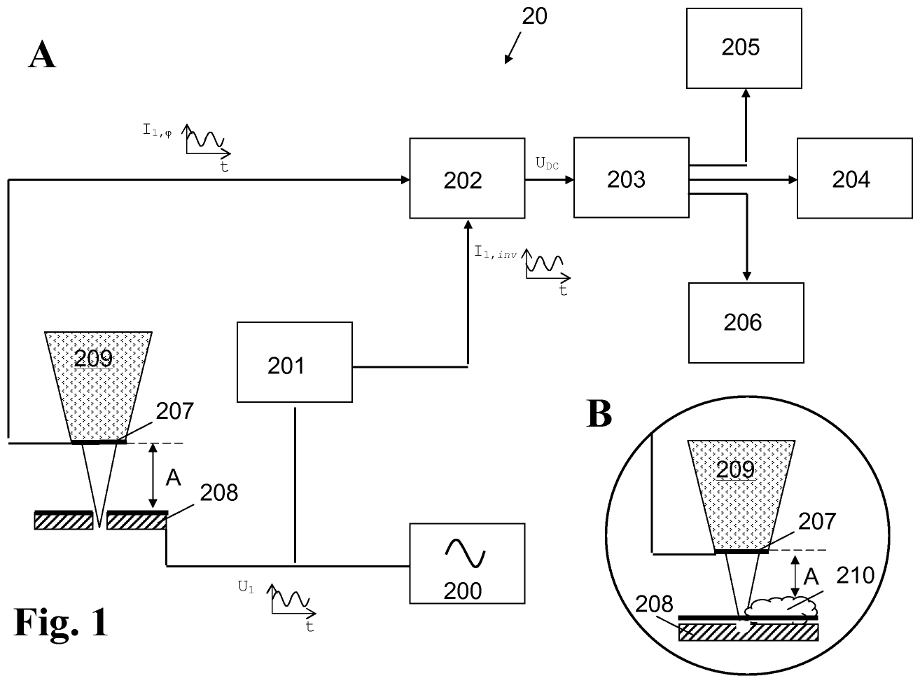

FIG. 1 shows a schematic circuit diagram of a loss of cut detection apparatus according to the invention, and

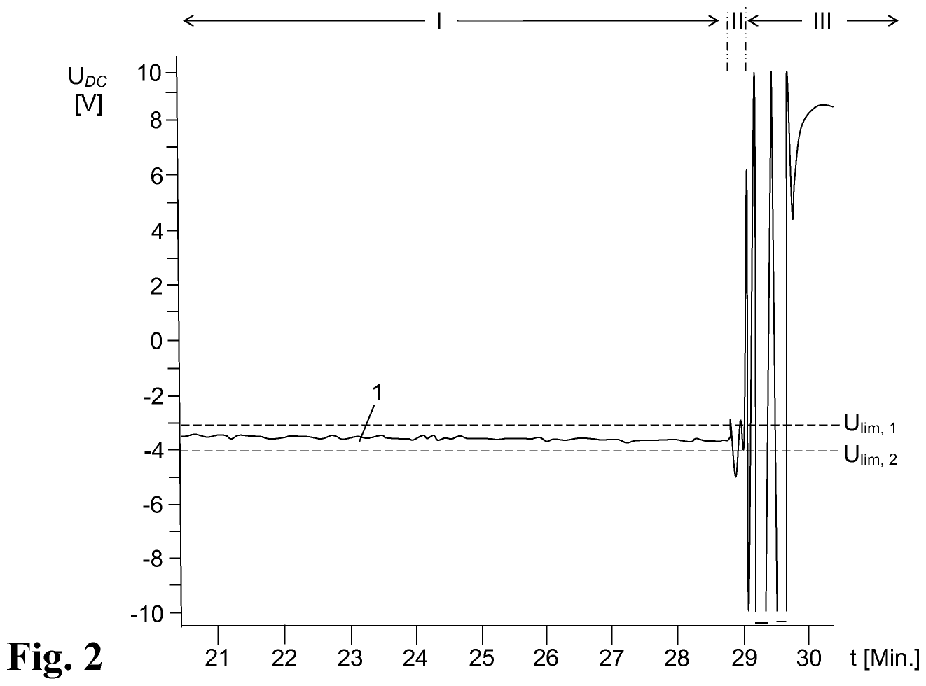

FIG. 2 shows a graph in which a phase shift DC voltage signal is illustrated as a function of time.

FIG. 1 shows a section A of a schematic circuit diagram of a loss of cut detection apparatus according to the invention, the whole of which is assigned the reference number 20. The apparatus 20 comprises an alternating signal generator 200, a measurement electrode 207, an inverter 201, a phase discriminator 202, a monitoring unit 203 and three independent electronic circuits 204, 205, 206.

The apparatus 20 is part of a laser cutting machine (not illustrated), as is used, for example, for cutting a planar workpiece 208 from metal, preferably from stainless steel, aluminum, copper or brass.

The laser cutting machine comprises a workbench having a contact face (not illustrated) for holding the workpiece 208 and a movable laser processing unit (likewise not illustrated) having a laser cutting head 209. The measurement electrode 207 is fas-tened to the laser cutting head 209. To set a prescribed distance of the laser cutting head 209 from the workpiece surface, a height sensor system (not illustrated) that determines the position of the laser cutting head 209 and hence of the measurement electrode 207 is provided.

In the following text, the method according to the invention is explained with reference to the laser cutting machine described above.

First, an alternating voltage signal U₁ (t) is applied to the workpiece 208. To this end, the alternating signal generator 200 generates the alternating voltage signal U₁ (t), which is applied to the workpiece 208 and is subsequently used as the reference signal.

The alternating voltage signal U₁ (t) causes an alternating current signal I_{1,φ}(t) in the measurement electrode 207. Both alternating signals U₁ (t) and I_{1,φ}(t) have identical periods; however, they differ in phase, wherein the alternating current signal I_{1,φ}(t) is phase-shifted with respect to the first alternating voltage signal U₁ (t) by the angle φ. In this case, the magnitude of the phase shift depends on the distance of the measurement electrode 207 from the workpiece 208, among other things. The alternating current signal I_{1,φ}(t) is identified by means of the measurement electrode 207.

Under normal cutting conditions, the distance between the measurement electrode 207 and the workpiece 208 is kept as constant as possible by the height sensor system—apart from regulation deviations. Although the alternating current signal I_{1,φ}(t) resulting therefrom has a certain level of noise, it exhibits an almost constant phase shift over time compared to the reference U₁ (t).

To ascertain the phase shift, the reference signal U₁ (t) is first inverted, that is to say is phase rotated by 180°, by means of the inverter 201. The inverter 201 delivers a phase-rotated alternating current signal I_{1,inv} (t) as output signal.

Both the phase-rotated alternating current signal I_{1,inv}(t) and the phase-shifted alternating current signal I_{1,φ}(t) are applied at the phase discriminator 202 as input signals. The phase discriminator 202 also contains a rectifier. If the alternating current signals I_{1,φ}(t) and I_{1,inv}(t) are not phase-shifted with respect to one another, they cancel each other out completely at the same amplitude level. In the case of a phase shift, however, a positive or a negative phase shift signal in the form of the DC voltage signal U_{DC} results depending on whether I_{1,φ}(t) I_{1,inv}(t) is leading or lagging. The magnitude of the signal is a measure for the phase angle Δφ, in which the phases of the signals differ. In order to make it possible to easily compare the signals, at least one of the signals applied at the phase discriminator 202 is optionally preamplified (not illustrated) in order to adjust the amplitude level of the two signals to one another.

The phase shift signal U_{DC} is then compared with a prescribed upper and lower limit value by the monitoring unit 203.

In normal cutting operation, the limit values are regularly not exceeded or undershot. However, if a loss of cut occurs, a plasma capsule 210 is produced on the top side of the workpiece 208. Said plasma capsule 210 is produced essentially by the coupling of high power peaks into the workpiece 208.

Section B shows the laser cutting head 209, the workpiece 208 and the plasma capsule 210 in the event of a loss of cut.

The plasma capsule 210 causes a change in the capacitance between the measurement electrode 207 and the top side of the workpiece 208. Moreover, detached workpiece components are accelerated in the direction of the nozzle or the measurement electrode 207 on account of the cutting kerf no longer penetrating the material. This results in a changed phase shift of the signals I_{1,φ}(t) and I_{1,inv} (t). Since the capacitance between the measurement electrode 207 and the top side of the workpiece 208 changes and fluctuates over the course of time on account of the changing plasma, a fluctuating phase shift signal U_{DC} is also obtained as the output signal of the phase discriminator 202, said phase shift signal being used to detect the loss of cut. To this end, the phase shift signal is monitored by the monitoring unit 203 for the exceeding of an upper limit value or the undershooting of a lower limit value. In the case of the exceeding or undershooting of the respective limit value:
the separation rate is reduced by means of the electronic circuit 204,
the measurement electrode is set at a prescribed fixed position by means of the electronic circuit 205, and
an optical and acoustic warning signal is output by means of the electronic circuit 206.

FIG. 2 shows by way of example a time profile of the phase shift voltage signal U_{DC} in the case of a good cut (section I), an impending loss of cut (section II) and after a loss of cut has occurred (section III). The phase shift signal is denoted by the reference number 1.

Before the loss of cut, the phase shift signal 1 has a conventional level of noise during the cutting process. Nevertheless, the phase shift signal 1 in section I is substantially constant and fluctuates with only a small deviation about a mean value. An impending loss of cut leads to oscillation of the phase shift signal 1 in section II up to full deflec-tion in section III.

In order to be able to counteract an impending loss of cut successfully and to prevent a loss of cut as a result, it is important to detect a loss of cut that is beginning at as early a stage as possible. The use of the phase shift signal makes it possible to detect a loss of cut at an early stage, in particular in section II. The upper limit value U_{lim,1} and the lower limit value U_{lim,2} are selected in such a way that they make detection at an early stage possible.

1. A method for detecting an impending loss of cut or a loss of cut that has already occurred during the thermal separation of a workpiece, in which energy is input into a cutting region, said method comprising the following steps:
a) applying a first alternating signal to the workpiece,
b) identifying a second alternating signal caused by the first alternating signal in a measurement electrode spaced apart from the workpiece,
c) ascertaining a phase shift between the first alternating signal and the second alternating signal by outputting a phase shift signal,
d) comparing the phase shift signal with a prescribed upper limit value and a prescribed lower limit value for the phase shift signal,
wherein, when the phase shift signal exceeds the upper limit value or undershoots the lower limit value, the energy input into the cutting region is changed.

2. The method as claimed in claim 1, wherein the thermal separation is effected at a separation rate and the energy input into the cutting region is changed by reducing the separation rate.

3. The method as claimed in claim 2, wherein the separation rate is reduced in steps.

4. The method as claimed in claim 2, wherein, after the reduction of the separation rate, the separation rate is increased again when the phase shift signal is back in a range between the lower and upper limit value.

5. The method as claimed in claim 1, wherein the energy input is changed by stopping the thermal separation of the workpiece.

6. The method as claimed in claim 5, wherein, after the stopping of the thermal separation of the workpiece, a separation process is started again from a loss of cut point.

7. The method as claimed in claim 1, wherein, during thermal separation, a distance of the measurement electrode from the workpiece is kept at a prescribed distance setpoint value using distance regulation and, when the phase shift signal exceeds the upper limit value or undershoots the lower limit value, the measurement electrode is set to a prescribed fixed height position.

8. The method as claimed in claim 7, wherein the prescribed fixed height position is ascertained from height values or distance values of the measurement electrode with respect to the workpiece surface in a time interval before the upper limit value is exceeded or the lower limit value is undershot.

9. The method as claimed in claim 1, wherein, when the phase shift signal exceeds the upper limit value or undershoots the lower limit value, a warning signal is output.

10. An apparatus for detecting an impending loss of cut or a loss of cut that has already occurred during the thermal separation of a workpiece, in which energy is input into a cutting region, said apparatus comprising:
an alternating signal generator generating a first alternating signal,
a measurement electrode, which is spaced apart from the workpiece, identifying a second alternating signal caused by the alternating signal in the measurement electrode,
a phase discriminator ascertaining a phase shift between the first alternating signal and the second alternating signal, wherein the phase discriminator outputs a phase shift signal, and
an electronic circuit comparing the phase shift signal with a prescribed upper limit value and a prescribed lower limit value of the phase shift signal, and
wherein the electronic circuit is configured so as to change the energy input into the cutting region when the upper limit value is exceeded or the lower limit value is undershot.

11. The apparatus as claimed in claim 10, wherein the electronic circuit is designed in such a way that it stops the thermal separation of the workpiece when the upper limit value is exceeded or the lower limit value is undershot.

12. The method as claimed in claim 3, wherein, after the reduction of the separation rate, the separation rate is increased again when the phase shift signal is back in the range between the lower and upper limit value.

13. The method as claimed in claim 2, wherein the energy input is changed by stopping the thermal separation of the workpiece.

14. The method as claimed in claim 3, wherein the energy input is changed by stopping the thermal separation of the workpiece.

15. The method as claimed in claim 4, wherein the energy input is changed by stopping the thermal separation of the workpiece.

16. The method as claimed in claim 12, wherein the energy input is changed by stopping the thermal separation of the workpiece.

17. The method as claimed in claim 2, wherein, during thermal separation, a distance of the measurement electrode from the workpiece is kept at a prescribed distance setpoint value using distance regulation and, when the phase shift signal exceeds the upper limit value or undershoots the lower limit value, the measurement electrode is set to a prescribed fixed height position.

18. The method as claimed in claim 3, wherein, during thermal separation, a distance of the measurement electrode from the workpiece is kept at a prescribed distance setpoint value using distance regulation and, when the phase shift signal exceeds the upper limit value or undershoots the lower limit value, the measurement electrode is set to a prescribed fixed height position.

19. The method as claimed in claim 4, wherein, during thermal separation, a distance of the measurement electrode from the workpiece is kept at a prescribed distance setpoint value using distance regulation and, when the phase shift signal exceeds the upper limit value or undershoots the lower limit value, the measurement electrode is set to a prescribed fixed height position.

20. The method as claimed in claim 5, wherein, during thermal separation, a distance of the measurement electrode from the workpiece is kept at a prescribed distance setpoint value using distance regulation and, when the phase shift signal exceeds the upper limit value or undershoots the lower limit value, the measurement electrode is set to a prescribed fixed height position.
